(19) United States
(12) Patent Application Publication
(10) Pub. No.: US 2026/0065667 A1
(43) Pub. Date: Mar. 5, 2026

(54) SYSTEMS AND METHODS FOR VISUALIZATION AND MANIPULATION OF GEOGRAPHIC SCENE VIEWS USING NON-COMPOSITE OBLIQUE IMAGERY

(71) Applicant: FNV IP B.V., Leidschendam (NL)

(72) Inventors: Justin RICHWAGEN, Frederick, MD (US); Azhar IBRAHIM, Brunswick, MD (US); Michael WERNAU, Leisburg, VA (US); Guy MEIRON, Boonsboro, MD (US)

(21) Appl. No.: 18/824,864

(22) Filed: Sep. 4, 2024

(51) Int. Cl. G06V 20/10; G06T 3/40; G06V 10/75

(52) U.S. Cl. CPC G06V 20/10; G06T 3/40; G06V 10/75; G06V 2201/10

(57) ABSTRACT

Described are systems and techniques for visualization and manipulation of non-composite oblique aerial imagery. One or more user inputs can be obtained by an oblique image visualization system associated with a plurality of non-composite oblique aerial images of a geographic area of interest. View perspective information indicative of a user-requested view of a scene or area within the geographic area of interest can be determined from the user inputs. One or more parameters of the view perspective information can be compared to a corresponding one or more parameters associated with each oblique image. A best match oblique image can be selected from the plurality of non-composite oblique aerial images based on the comparison. The best match oblique image can be output for display by the oblique image visualization system in response to the user-requested view.

### FIELD

Aspects of the present disclosure generally relate to the visualization and rendering of map data, including geographic information system (GIS) data or other aerial imagery. For example, aspects of the present disclosure are related to the visualization and manipulation of geographic scene views corresponding to a plurality of non-composite oblique images, without performing image stitching or alignment for the plurality of non-composite oblique images.

### BACKGROUND

Geographic information system (GIS) and other map and/or imagery data visualization systems often utilize orthogonal or top-down aerial imagery to provide a more detailed view of a geographic area or geographic scene of interest. Orthogonal images may also be referred to as “ortho” images or “orthoimagery”, and can be captured using a camera positioned at some height above the ground surface and oriented at an approximately orthogonal angle (e.g., perpendicular) to the ground surface or ground reference plane. Orthogonal images can be captured by cameras mounted to an airborne vehicle such as a plane, helicopter, drone, UAV, etc., as the airborne vehicle is flown in a pattern over a geographic area or region that is to be mapped by the resulting orthogonal imagery data. In another example, orthogonal images can be captured by satellites having one or more cameras with imaging axes oriented orthogonal to the ground surface or ground reference plane. Orthogonal aerial imagery may be adjusted for topographic features or topographic relief, lens distortion, atmospheric distortion, etc., and is often used in mapping and visualization applications as a baseline representation to provide accurate and uniform scaling across different geographic scenes or views.

Orthogonal aerial imagery can be considered a first type of aerial imagery, associated with capturing top-down views at an angle of approximately 90° between the imaging axis of the camera and the surface of the ground. Oblique aerial imagery is another type of aerial imagery, associated with capturing side-angle views at angles less than 90° between the imaging axis of the camera and the surface of the ground. For example, oblique aerial images may be taken at angles of 40° to 60° from relatively low-flying aircraft, as well as from various other non-orthogonal angles with respect to the ground surface or ground reference plane. The side-angle perspective provided by oblique images can allow the sides of buildings, structures, and terrain features to be seen, and may additionally provide a more natural perspective to the human eye. Oblique images can be captured from various different tilt angles (e.g., the angle between the camera imaging axis and the ground) and/or from different orientations. In some examples, oblique imagery can be captured using camera systems that are configured to simultaneously capture multiple oblique images in multiple different directions or orientations in the horizontal plane. For example, an oblique imaging system may use four separate cameras or imaging sensors to perform simultaneous capture of respective oblique images in each of the four cardinal directions (a first camera captures oblique images from a north-facing orientation, a second camera captures oblique images from an east-facing orientation, a third camera captures oblique images from a south-facing orientation, and a fourth camera captures oblique images from a west-facing orientation).

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In one illustrative example, a method of oblique imagery visualization can include: obtaining one or more user inputs to an oblique image visualization system, wherein the oblique image visualization system is associated with a plurality of non-composite oblique aerial images of a geographic area; determining, based on the one or more user inputs, view perspective information indicative of a user-requested view of a scene or area within the geographic area; comparing one or more parameters of the view perspective information to a corresponding one or more parameters associated with each oblique image of the plurality of non-composite oblique aerial images; selecting a best match oblique image from the plurality of non-composite oblique aerial images based on the comparison; and outputting the best match oblique image for display by the oblique image visualization system in response to the user-requested view.

In some aspects, the method can further include determining a difference between values of the one or more parameters of the view perspective information and respective values of the corresponding one or more parameters associated with each oblique image.

In some aspects, the best match oblique image is selected based on having a minimum difference from the values of the one or more parameters of the view perspective information.

In some aspects, the geographic area is a geographic area of interest identified from one or more user inputs, and the view perspective information includes at least a center point coordinate of the user-requested view of the scene or area within the geographic area of interest.

In some aspects, each oblique image of the plurality of non-composite oblique aerial images is associated with a respective image frame center coordinate; and the best match oblique image is selected based on having a smallest distance between the center point coordinate of the user-requested view and the respective image frame center coordinate.

In some aspects, the center point coordinate of the user-requested view and the respective image frame center coordinate for each oblique image are defined using a same common coordinate system.

In some aspects, the view perspective information is indicative of one or more of: a center point coordinate of the user-requested view; an oblique view angle of the user-requested view; a heading or orientation angle of the user-requested view; or a zoom level of the user-requested view.

In some aspects, the method further includes filtering the plurality of non-composite oblique aerial images to obtain a filtered subset of oblique images, wherein the filtered subset of oblique images each have corresponding parameter values matching with one or more of the oblique view angle and the heading or orientation angle of the user-requested view.

In some aspects, the best match oblique image is determined based on a calculated straight line distance between the center point coordinate of the user-requested view and a respective image frame center coordinate for each oblique image included in the filtered subset.

In some aspects, determining the calculated straight line distance is skipped for each oblique image of the plurality of non-composite oblique aerial images that is not included in the filtered subset.

In some aspects, outputting the best match oblique image for display includes cropping the best match oblique image data to match the user-requested view of the scene or area within the geographic area.

In some aspects, the best match oblique image data is cropped based on one or more of a configured zoom level or a configured center point coordinate indicated in the view perspective information for the user-requested view.

In another illustrative example, an apparatus is provided. The apparatus includes at least one memory and at least one processor coupled to the at least one memory and configured to: obtain one or more user inputs to an oblique image visualization system, wherein the oblique image visualization system is associated with a plurality of non-composite oblique aerial images of a geographic area; determine, based on the one or more user inputs, view perspective information indicative of a user-requested view of a scene or area within the geographic area; compare one or more parameters of the view perspective information to a corresponding one or more parameters associated with each oblique image of the plurality of non-composite oblique aerial images; select a best match oblique image from the plurality of non-composite oblique aerial images based on the comparison; and output the best match oblique image for display by the oblique image visualization system in response to the user-requested view.

In another illustrative example, a non-transitory computer-readable storage medium comprising instructions stored thereon which, when executed by at least one processor, causes the at least one processor to: obtain one or more user inputs to an oblique image visualization system, wherein the oblique image visualization system is associated with a plurality of non-composite oblique aerial images of a geographic area; determine, based on the one or more user inputs, view perspective information indicative of a user-requested view of a scene or area within the geographic area; compare one or more parameters of the view perspective information to a corresponding one or more parameters associated with each oblique image of the plurality of non-composite oblique aerial images; select a best match oblique image from the plurality of non-composite oblique aerial images based on the comparison; and output the best match oblique image for display by the oblique image visualization system in response to the user-requested view.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are therefore not to be considered to be limiting of its scope, the principles herein are described and explained with additional specificity and detail through the use of the accompanying drawings in which:

FIG. 1 is a diagram illustrating an example of geographic scene visualization based on stitching or compositing of a plurality of images into a composite image, in accordance with some examples;

FIG. 2 is a diagram illustrating an example of geographic scene visualization using configured or requested view perspective information to determine a matching non-composite image, in accordance with some examples;

FIG. 3 is a diagram illustrating an example of an oblique imagery visualization system configured to use view perspective information and a corresponding view-based query for generating a rendered output view of a selected non-composite oblique image, in accordance with some examples;

FIG. 4 is a diagram illustrating an example of a panning operation corresponding to first and second view frames of a geographic scene visualization, wherein the first and second view frames are based on separate and non-composite oblique images, in accordance with some examples;

FIG. 5 is a diagram illustrating an example of a rotation operation corresponding to first and second view frames of a geographic scene visualization, wherein the first and second view frames are based on separate and non-composite oblique images, in accordance with some examples;

FIG. 6 is a flow diagram illustrating an example of a process for using orthographic projection information of a building floor interior, in accordance with some examples; and

FIG. 7 is a block diagram illustrating an example of a computing system for implementing certain embodiments of the present technology, according to embodiments of the present disclosure.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

As noted previously, aerial imagery data and/or aerial mapping data (including GIS data, etc.) can be divided into orthogonal images, captured at an approximately 90° angle between the camera and the ground, and oblique images, capture at angles of less than 90° between the camera and the ground. Orthogonal images provide a top-down perspective that can be geometrically corrected to achieve a uniform scale and minimize perspective distortions across the individual images of a set of multiple different orthogonal images. For example, the 90° angle between the camera and the ground that is used when capturing orthogonal images can result in an approximately constant scale across the pixels of a single orthogonal image (e.g., same distance per pixel for each pixel of an orthogonal image) and an approximately constant scale between multiple orthogonal images (e.g., same distance per pixel for the pixels included in each different orthogonal image).

The consistent top-down perspective and pixel scale associated with orthogonal aerial imagery can be leveraged to perform image stitching or tiling to align the borders of the separate orthogonal images captured for adjacent geographic areas, to thereby generate a seamless and continuous composite image for a larger geographic area or region that is mapped in a dataset comprising a plurality of orthogonal images. For example, image stitching for orthogonal images can be performed based on acquiring multiple overlapping images in both the forward and lateral directions, and using computer vision or other feature recognition and/or feature matching techniques to align adjacent images based on distinct features found in the overlapping portions of adjacent orthogonal images. The features used for stitching orthogonal images into a larger, singular composite image can include geographic or terrain features (e.g., objects that are depicted in the images themselves), and/or can include properties and characteristics of the image such as corners, edges, unique patterns, etc. Based on identifying the same feature in an overlapping portion between adjacent orthogonal images, relative positioning and orientation information (and in some cases, scaling information) can be calculated to transform and align the separate orthogonal images for stitching into what appears to the viewer as a single continuous or seamless image spanning the field of view of the combined orthogonal images as a whole.

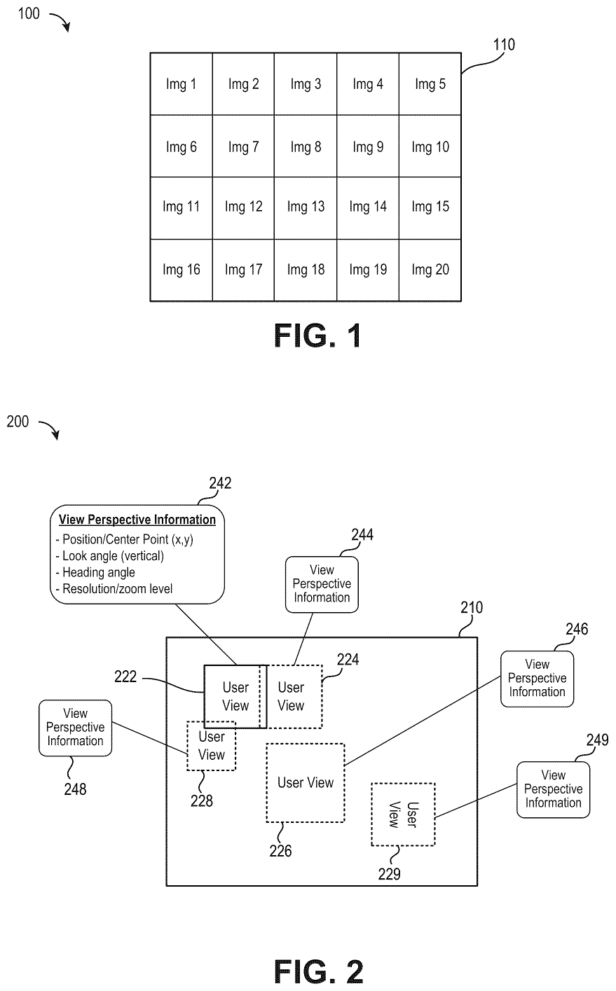

For example, FIG. 1 is a diagram illustrating an example of geographic scene visualization 100 based on stitching or compositing of a plurality of images into a composite image 110, in accordance with some examples. For instance, FIG. 1 provides a schematic representation of a composite image 110 that can be generated based on stitching, combining, blending, mosaicking, tiling, etc., a plurality of separate images (e.g., Img 1, Img 2, . . . , Img 20, etc.) to be aligned with one another. The plurality of separate images can be orthogonal images that are at least partially overlapping with one or more adjacent images, with the overlap used to perform the feature matching and alignment as described above. Stitching the plurality of separate images into the singular, composite image 110 allows users (e.g., users of a geographic scene viewer that provides visualization, interaction, and/or manipulation of the composite image 110) to pan, scroll, and/or rotate to different viewpoints within the composite image 110 without noticing sudden or abrupt transitions when changing the view frame from an area that was captured in the image data of a first image (e.g., Img 1) to an area that was captured in the image data of a different/second image (e.g., Img 2, Img 6, etc.).

Geographic viewer functionality that is implemented for composite images or other stitched sets of aerial imagery may be based on rendering a requested viewpoint or view frame directly from underlying data (or data object(s)) generated and stored for the singular, composite image itself. In other words, geographic viewers that display view frames of a composite image previously generated from performing image stitching for a plurality of separately captured images do not access or render the output from the respective data of each separately captured image, and instead access and render the output based on using a corresponding subset of the data that was generated for the single composite image.

Performing the image stitching operations to generate the singular, composite image from a plurality of separately captured images (e.g., such as a plurality of aerial orthogonal images captured at various areas or locations within the larger geographic area or region that is to be represented in the composite image 110) can be computationally complex, time-consuming, and cumbersome. It would be desirable to provide systems and techniques that can provide geographic scene views and manipulations of the configured viewpoint or view perspective without the need to previously generate, store, and then access a calculated composite image.

Image stitching may additionally be challenging or impossible to perform for oblique aerial imagery and oblique imagery datasets, for instance based on the scale variations and distortions and/or perspective changes that are present across different oblique image views. For example, unlike orthogonal imagery which is captured from a consistent top-down perspective and may be geometrically corrected to a uniform scale, oblique images can include perspective distortions and scale variations. In oblique images, objects in the captured image can vary in their distance from the camera or imaging sensor, which can cause perspective and scale distortions.

In orthogonal images, objects in the captured image are all approximately the same distance from the camera (disregarding vertical height differences of objects perpendicular to the ground, as such height differences are effectively compressed in orthogonal images based on the imaging axis also being perpendicular to the ground). However, in oblique imagery, the tilt angle of the camera used to capture the image (e.g., the angle between the camera and the ground, where the angle is less than) 90° causes the objects in frame to vary in their distance from the camera. For example, the objects in the lower half of an oblique aerial image are typically closer to the camera than the objects in the upper half of the oblique aerial image. Based on the varying distance to the camera for objects within the same oblique image, the objects closer to the camera will appear larger than more distant objects, and the scale (e.g., distance or length per pixel, etc.) within a given oblique image is not constant. In one illustrative example, pixels in the lower half of an oblique image may have a scale of approximately 2 feet per pixel (as the lower half of the camera field of view is physically at a closer distance from the camera sensor) while pixels in the upper half of the same oblique image may have a scale of approximately 5 feet per pixel (as the upper half of the camera field of view is physically at a farther distance from the camera sensor). This behavior can also be referred to as the ground sample distance (GSD) associated with an oblique aerial image, or the pixels thereof. For instance, pixels in the foreground of an oblique aerial image may have a smaller GDS than pixels in the background of the oblique aerial image. In an illustrative example, a building near the foreground of an oblique image may have a GSD of 5 cm/pixel, while a building near the background of the oblique image may have a GSD of 30 cm/pixel.

The perspective distortions and variations in scale/GSD both within individual oblique images and across different oblique images can make it difficult or impossible to use oblique aerial imagery for direct size and distance comparisons, without first performing normalization or otherwise converting between the different GSD and perspective at the two different locations that are to be compared within an oblique image or across multiple oblique images. In some aspects, orthogonal imagery can be approximately taken to use a single, consistent scale both within individual orthogonal images and across the different orthogonal images captured in a dataset comprising a plurality of orthogonal images. By contrast, oblique imagery can be approximately taken as having an infinite number of local scales. Additional processing, normalization, and/or geometric corrections may therefore be required before existing techniques of image stitching can be applied for oblique imagery datasets. In some cases, oblique imagery viewers do not perform stitching to generate a composite oblique image for presentation to a user for visualization and manipulation. However, oblique imagery datasets may include thousands of different oblique images of an area of interest, and are not useful or are very cumbersome and challenging to interact with, view, and interpret without a viewer system that provides some form of view-oriented context (e.g., also referred to as a scene or geographic scene) to arrange and relate the individual oblique images with respect to one another. As such, there is an additional need for systems and techniques that can be used to more effectively and more efficiently provide visualization and manipulation of a geographic scene view for an area of interest (e.g., an imaged area) that is represented within a plurality of individual, non-composite oblique aerial images. There is a further need for systems and techniques that can be used to provide visualization and manipulation (e.g., panning, rotation, etc.) of an oblique imagery scene without requiring computationally complex and time-consuming normalization and/or stitching image processing operations to be performed to first generate a composite image that may be used as the basis for the oblique scene viewer.

The present technology includes systems, methods, and computer-readable media (also referred to as “systems and techniques”) for solving these problems and discrepancies. For example, disclosed are systems and techniques that can be used to provide visualization and manipulation of geographic scene views of non-composite oblique imagery datasets (e.g., without generating a composite image from the plurality of oblique images included within an oblique imagery dataset). The individual oblique images can be organized and displayed to a user as a geographic scene corresponding to the area of interest that is imaged by or within the plurality of oblique images of the oblique imagery dataset. For example, the organization and presentation of the oblique images as a geographic scene can approximate the experience of viewing and interacting with (e.g., manipulating the view by panning, rotating, zooming, etc.) a true composite image.

For example, the systems and techniques can determine the configured or desired view perspective or viewpoint into the geographic scene, based on one or more user inputs to a graphical user interface (GUI) of the oblique viewer described herein, and can automatically and in substantially real-time identify, fetch, and display the corresponding portion(s) of a best-fit or best-match singular oblique image. For example, the visualization and manipulation of a composite or stitched geographic scene can be simulated or approximated by the systems and techniques described herein, based on using a best-fit approach to identify the individual oblique image that most closely matches to the current view perspective information or current view perspective parameters that are set for or within the oblique imagery viewer by a user.

For example, FIG. 2 is a diagram illustrating an example of geographic scene visualization 200 using configured or requested view perspective information indicative of a user's desired view of (e.g., into) a geographic scene 210 that corresponds to a plurality of non-composite oblique aerial images. For example, the geographic scene 210 may correspond to a plurality of singular or individual (e.g., discrete) oblique aerial images that each depict a subset or respective portion of the larger area of the geographic scene 210. The plurality of individual oblique aerial images may be overlapping or non-overlapping, and can be included in one or multiple oblique imagery datasets and/or oblique imagery capture sessions, etc.

As will be described in further detail below, the systems and techniques can be used to implement an oblique imagery viewer for non-composite oblique imagery, based on view perspective information corresponding to or otherwise indicative of a desired view of the geographic scene 210. As illustrated in the example of FIG. 2, different configurations of desired scene views are represented as the user views 222, 224, 226, 228, and 229. The desired scene views may also be referred to as scene view configurations, requested scene views, requested viewpoints, requested scene perspectives, etc.

The different scene views 222-229 can each correspond to a respective set of view perspective information, indicative of information that uniquely characterizes the subset of the overall geographic scene 210 that is requested for viewing by a user of the oblique imagery viewer. For instance, the scene view 222 can correspond to the view perspective information 242; the scene view 224 can correspond to the view perspective information 244; the scene view 226 can correspond to the view perspective information 246; the scene view 228 can correspond to the view perspective information 248; and the scene view 229 can correspond to the view perspective information 249; etc.

Different scene views can correspond to different locations of the area or region within the geographic scene 210 that the user wishes to view in the display output of the non-composite oblique imagery viewer described herein. For example, the user can input one or more scene manipulation commands or otherwise indicate one or more scene manipulation or visualization operations to cause the oblique imagery viewer to update the display output from a first scene view to a second scene view, both within the same overall geographic scene 210 that corresponds to the underlying set of individual oblique aerial images. The scene manipulation commands for changing between different views can include one or more of a horizontal translation (e.g., shifting the center point of the desired scene view right or left, corresponding to increasing or decreasing the x-coordinate of the scene view center coordinate (x,y)); a vertical translation (e.g., shifting the center point of the desired scene view up or down, corresponding to increasing or decreasing the y-coordinate of the scene view center coordinate (x,y)); a rotation (e.g., changing the orientation or heading angle of the desired scene view to an larger or smaller angular value, corresponding to rotating clockwise or counter-clockwise); a change in zoom level (e.g., zooming in or out on the geographic scene 210, corresponding to increasing or decreasing the zoom level); a change in the look angle of the oblique imagery (e.g., tilting up or down relative to the ground surface, corresponding to increasing or decreasing the vertical look/tilt angle, which may be the same as or mapped to the view angle used to capture an oblique aerial image).

Each of the configured or requested user views 222-229 can be associated with a corresponding view perspective information 242-249. Each set of view perspective information 242-249 can include the same fields, with respective values corresponding to the particular user view associated with the set of view perspective information. For example, each set of view perspective information 242-249 can include a position or center point coordinate (e.g., an (x,y) coordinate) of the central point of the corresponding scene view 222-229, respectively.

In some aspects, the coordinate system used for the position or center point information included in the view perspective information 242-249 can be a constant or baseline coordinate system that is used to georeferenced the different possible scene views and the underlying plurality of non-composite oblique aerial images to the same coordinate system and reference point(s). In some embodiments, the view perspective information 242-249 can include center point (x,y) coordinates that utilize the same coordinate system that is used to represent location or position information uniquely associated to each one of a plurality of oblique aerial images captured for the geographic scene area 210. For example, the common coordinate system can be a native coordinate system used for logging position information of each oblique aerial image at the time of capture during aerial oblique imagery surveying operations, etc. In some aspects, the common coordinate system can be a converted coordinate system that is different from the coordinate system used to log position or location information of each oblique aerial image at its time of capture (e.g., such that the oblique aerial images and the scene view perspective central points are both converted to the common coordinate system. In some embodiments, the common coordinate system can be implemented as a geographic coordinate system (GCS) associated with a GIS platform or GIS viewer application used by the disclosed non-composite oblique aerial imagery viewer.

The view perspective information 242-249 can further include a vertical look angle of the corresponding scene viewpoint configuration 222-249; a horizontal heading angle or orientation of the corresponding scene viewpoint configuration 222-249; and a resolution/zoom level of the corresponding scene viewpoint configuration 222-249. In one illustrative example, the scene viewpoints 222 and 224 (and the corresponding view perspective information 242 and 244, respectively) can include the same y-coordinate value of the center point and a different x-coordinate value of the center point. The view perspective information 242 and 244 may additionally include the same look angle value, based on the scene views 222 and 224 having the same vertical look/tilt angle as one another; may additionally include the same heading angle value, based on the scene views 222 and 224 having the same orientation (e.g., north-facing) angle as one another; and may additionally include the same resolution/zoom level value as one another, based on the scene views 222 and 224 having the same zoom level as one another (e.g., scene views 222 and 224 are of equal size).

In another example, the view perspective information 248 can include a different position/(x,y) center point coordinate than the view perspective information 242, based on the scene views 222 and 228 having different central point locations within the geographic scene area 210; can include a different resolution/zoom level than the view perspective information 242, based on the scene view 228 being smaller (e.g., higher zoom level) than the scene view 222; and can have the same orientation/heading angle as the view perspective information 242, based on the scene views 222 and 228 both having the same orientation (e.g., north-facing) angle as one another.

In another example, the view perspective information 246 can include a different position/(x,y) center point coordinate than the view perspective information 242, based on the scene views 222 and 224 having different central point locations within the geographic scene area 210; can include a different resolution/zoom level than the view perspective information 242, based on the scene view 226 being larger (e.g., smaller zoom level) than the scene view 222; and can have the same orientation/heading angle as the view perspective information 242, based on the scene views 222 and 226 both having the same orientation (e.g., north-facing) angle as one another.

In yet another example, the view perspective information 249 can include a different position/(x,y) center point coordinate than the view perspective information 242, based on the scene views 229 and 224 having different central point locations within the geographic scene area 210; can include a different heading angle from the view perspective information 242, based on the scene view 229 having a different orientation angle (e.g., east-facing) than the orientation angle of the scene view 222 (e.g., which is north-facing); and can have a same resolution/zoom level as the view perspective information 242, based on the scene view 229 and the scene view 222 being of equal size (e.g., same zoom level) as one another within the geographic scene area 210.

In some embodiments, the view perspective information 242-249 corresponding to a user configuration or request for the scene view area 222-249 within the overall geographic scene area 210 can be obtained or determined based on one or more user inputs to the disclosed non-composite oblique imagery viewer. For example, user inputs to adjust or manipulate the scene view area displayed in the GUI of the oblique viewer may be received as one or more mouse or pointer/cursor inputs, one or more keyboard inputs, or various combinations thereof. The user inputs corresponding to manipulations or changes to the displayed scene view area within the oblique viewer GUI can be used to determine the view perspective information 242-249, which itself may be used to determine a best-fit matching oblique image to display to the user, as will be described in greater detail below.

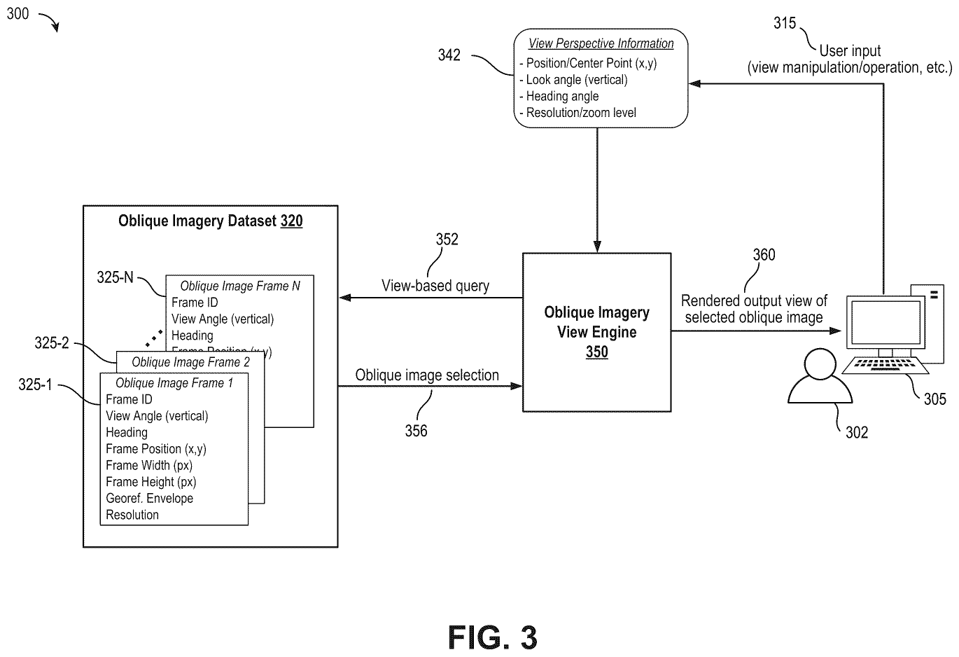

FIG. 3 is a diagram illustrating an example of an oblique imagery visualization system 300 configured to use view perspective information and a corresponding view-based query for generating a rendered output view of a selected non-composite oblique image, in accordance with some examples. The oblique imagery visualization system 300 can include an oblique imagery view engine 350 and one or more oblique imagery datasets 320. Each oblique imagery dataset 320 can include a respective plurality of oblique aerial images. For instance, in the example of FIG. 3, the oblique imagery dataset 320 can include a quantity N of individual (e.g., singular, discrete, etc.) oblique aerial images 325-1, 325-2, . . . , 325-N. In some aspects, the plurality of N oblique aerial images within the oblique imagery dataset 320 may be obtained in the same surveying or oblique imaging capture session. In some examples, the plurality of N oblique aerial images within the oblique imagery dataset 320 can be obtained in multiple different survey or oblique imagery capture sessions, including survey/capture sessions performed on different dates, with different imaging equipment, with different survey patterns or operational parameters, etc. In some embodiments, the individual oblique images 325-1-325-N within the oblique dataset 320 can correspond to respective portions or areas within the same, larger geographic region or geographic scene area. For example, the oblique images 325-1-325-N may each correspond to a respective imaged area comprising a subset of the geographic scene area 210 of FIG. 2, etc.

In some cases, each oblique image of the plurality of oblique images 325-1-325-N within the oblique dataset 320 can be identified with respective oblique image frame information. For example, each oblique image of the plurality of oblique images 325-1-325-N can be identified and stored (e.g., within the oblique dataset 320, or a database storing the oblique dataset 320, etc.) with some or all of: a frame identifier (ID) or unique file name that uniquely identifies each individual oblique image 325-1-325-N of the plurality of oblique images in the dataset 320; a look angle (e.g., a vertical tilt angle corresponding to the oblique imaging angle <90 degrees that was used to capture the respective oblique image—also referred to as a view angle); a heading angle or orientation angle used to capture the respective oblique image (e.g., provided as an angular value between 0-360 degrees, provided as one of set of discrete and pre-defined angular values such as 45 degree increments from 0-360, provided as one of a set of discrete and pre-defined angular indications such as the cardinal directions north, south, east, west, etc.); a frame position in (x,y) coordinates; a frame width in pixels; a frame height in pixels; a georeferenced envelope; and a resolution, zoom level, and/or GSD associated with the respective oblique image frame or portions thereof; etc.

As noted previously, the oblique image frame information associated with each oblique image 325-1-325-N in the oblique imagery dataset 320 can utilize the same coordinate system and/or georeferenced coordinate positions as are used for representing the central point (x,y) coordinates of the user's requested or configured scene view perspective (e.g., such as the scene view perspectives 222-229 of FIG. 2, etc.). Based on the same coordinate system being used for each oblique image 325-1-325-N and the requested view perspective information 342 for the rendered output to be displayed by the oblique imagery view system 300, the oblique imagery view engine 350 can perform best-fit matching to identify and select one oblique image from the plurality of oblique images in the dataset 320 as the best fit match that most closely corresponds to the requested scene view perspective 342.

In some embodiments, the scene view perspective information 342 shown in FIG. 3 can be the same as or similar to the scene view perspective information 242-249 shown in FIG. 2 and described previously above. For example, the scene view perspective information 342 can be based on one or more user inputs 315 indicative of a scene view manipulation or operation for changing or adjusting the displayed view of the oblique imagery geographic scene from the oblique imagery system 300. The user inputs 315 can be received from a user 302 of the oblique viewer system 300. For example, the user 302 can be associated with a user computing device 305 that is configured to communicate with or otherwise receive data of a rendered output view 360 of a selected oblique image from the oblique imagery view engine 350. The rendered output view 360 of the oblique image can be displayed to a user via a GUI of the system 300, which may be presented or rendered to the user 302 via a GUI shown on one or more displays of or associated with the user computing device 305. User input devices of the user computing device 302 can include a keyboard, mouse, trackpad, touchpad, touchscreen, etc., and can receive the one or more user inputs 315 from the user 302, where the received user inputs 315 are indicative of the requested or desired view manipulations or operations to adjust, change, or update the oblique imagery scene view of the rendered output 360 from the oblique imagery viewer system 300.

In some embodiments, each user interaction or user input 315 to the user computing device 305 running the oblique viewer system 300 and/or the oblique imagery view engine 350 can correspond to a new (e.g., current) view perspective information 342 being generated or obtained, and provided as input to the oblique imagery view engine 350.

For each input of view perspective information 342 received by the oblique imagery view engine 350, the oblique imagery view engine 350 can be configured to perform best-fit matching between the view perspective information 342 and the individual oblique images 325-1-325-N within the oblique dataset 320. In some embodiments, the oblique imagery view engine 350 can use the view perspective information 342 to generate or determine a corresponding view-based query 352 that can be used to query the oblique imagery dataset 320 to find the best-fit matching oblique image having an imaged perspective or imaged viewpoint (e.g., as indicated by the oblique image frame information 325-1-325-N described above) that most closely matches the requested viewpoint into the geographic scene indicated by the user input 315 to the oblique viewer system 300 GUI on the user computing device 305.

The plurality of oblique images 325-1-325-N can be stored in the oblique dataset 320 without relational links between the different oblique images. The view-based query 352 can include or be indicative of some, or all, of the view perspective information 342 provided to the oblique imagery view engine 350 in order to determine an update for the rendered output view 360 of an oblique image best matching to the user 302's requested viewpoint into the overall oblique imagery geographic scene. The oblique imagery view engine 350 can use the user's requested perspective as indicated by the view perspective information 342 (e.g., position, look angle, heading, zoom level/resolution) to determine the best-matching or best-fit oblique image within the oblique dataset 320. For example, the view-based query 352 may include the user's requested position, look angle, heading, and zoom level values from the view perspective information 342, which can be compared and analyzed against the corresponding position, view angle, heading, and resolution information stored in the dataset 320 for each respective oblique image of the plurality of oblique images 325-1-325-N.

For example, the center point position or (x,y) coordinate of the view perspective information 342 can be encoded in the view-based query 352 and compared/analyzed against the respective frame center point position for each oblique image 325-1-325-N within the oblique dataset 320. In one illustrative example, the comparison of center point positions can be based on calculating a distance between the (x,y) center point coordinate of the view perspective information 342, and the (x,y) center point coordinate of each oblique image 325-1-325-N (e.g., based on the same coordinate system being used for both the view perspective information 342 and the oblique image dataset 320 positions). In some embodiments, the best-match oblique image selection 356 can be selected, identified, or otherwise determined as the oblique image in the dataset 320 having the shortest (e.g., smallest) straight-line distance from the oblique image center point to the requested view perspective information 342 center point. For example, in some aspects, the best-match oblique image selection may have a distance of a single pixel from the oblique image center point to the requested view perspective information 342 center point (e.g., the minimum possible distance that may be determined by the best-match oblique image selection 356 can be zero). In some examples, the minimum possible distance that may be determined by the best-match oblique image selection 356 may correspond to a distance of a single pixel (e.g., one pixel) from the oblique image center point to the requested view perspective information 342 center point. In some cases, a maximum possible distance that may be determined by the best-match oblique image selection 356 can be equal to and/or may otherwise correspond to one or more dimensions and/or boundaries of the geographic area (e.g., area of interest) represented within the oblique imagery dataset 320. For example, the maximum possible distance that may be determined by the best-match oblique image selection 356 may be equal to or correspond to a height or width of the geographic scene area (e.g., in pixels or other units), such as a height or width of the geographic scene area 210 of FIG. 2, etc.

In some examples, the look angle of the view perspective information 342 can be used to filter the oblique image dataset 320 to only perform the center point distance calculation for the subset of oblique images in that dataset 320 having a matching look angle (e.g., the view angle of the oblique image). In such examples, the distance from the center point (x,y) coordinate of the view perspective information 342 to an oblique image center point (x,y) coordinate is calculated if the oblique image has a view angle that matches the specified vertical look angle in the view perspective information 342. The distance calculation may be skipped (e.g., not performed) if it is determined during the filtering step that the oblique image was captured at a view angle that does not match and/or differs from the look angle indicated in the view perspective information 342.

Similarly, the heading angle indicated in the view perspective information 342 may additionally, or alternatively, be used to perform an initial filtering of the plurality of oblique images 325-1-325-N within the oblique dataset 320, to identify the subset of oblique images that were captured with an orientation that matches the specified heading angle. For example, the center point distance calculation can be performed to identify the best-fit matching oblique image selection 356 from only the subset of oblique images within the dataset 320 that are determined in the first stage filtering to have a capture orientation that matches the specified heading angle of the view perspective information 342. Skipping the distance calculation and comparison for oblique images with a capture orientation that does not match the indicated heading angle of the view perspective information 342, and/or for oblique images with a vertical view angle that does not match the indicated tilt angle of the view perspective information 342 can improve the efficiency and speed of the best-fit oblique image selection 356 by culling the non-matching oblique image candidates that can be eliminated from best-fit match consideration based on at least one variable other than the center point distance.

In some embodiments, the oblique image selection 356 can return information indicative of one, singular oblique image within the dataset 320 that was identified as having the shortest straight-line distance between its respective center point and the indicated center point of the view perspective information 342. In some examples, the best-fit matching evaluation can utilize one or more additional criteria to choose between multiple oblique images having the same straight-line distance to the indicated center point coordinate from the view perspective information 342.

In some aspects, the oblique imagery view engine 350 can be further configured to generate the rendered output view 360 of the oblique imagery scene for the indicated view perspective information 342, based on using at least a portion of the image data contained in the selected best-fit match oblique image 356. For example, the oblique imagery view engine 350 can generate the rendered output view 360 using at least a portion of the best-fit match oblique image 356, where the portion of the image data to be used in the rendered output view 360 is determined based on the view perspective information 342.

For instance, the view perspective information 342 may specify a resolution/zoom level that is greater than the native zoom level of the selected oblique image 356 as captured. The oblique imagery view engine 350 may generate the rendered output view 360 based on cropping the selected oblique image 356 according to the requested zoom level of the view perspective information 342, and the native/captured zoom level of the selected oblique image 356. The oblique imagery view engine 350 can additionally perform the cropping within the frame of the selected oblique image 356 (e.g., with the oblique image frame determined based on the x,y center point position and the frame height and width information stored for the selected oblique image 356 in the dataset 320), such that the desired position is centered in the rendered output view. In other words, the selected oblique image 356 is identified as the oblique image with a natural center point (e.g., the center point of the entire oblique image frame) that is nearest to the requested center point specified in the view perspective information 342. However, the distance between center points may, in many cases, be a non-zero value.

A non-zero distance between the natural center point of the selected oblique image 356 as captured, and the specified center point for the view perspective information 342, can trigger the oblique imagery view engine 4350 to perform the cropping such that the center point of the cropped, rendered output view 360 has the same (x,y) center point as was requested in the view perspective information 342.

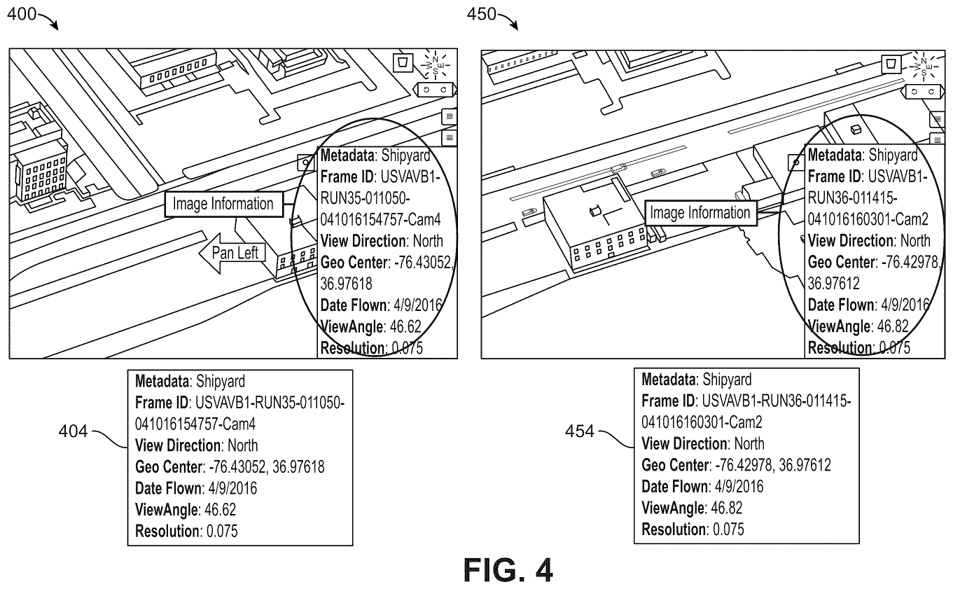

FIG. 4 is a diagram illustrating an example of a panning operation corresponding to first view frame 400 and a second view frame 450 of a geographic scene visualization, wherein the first and second view frames are based on separate and non-composite oblique images, in accordance with some examples. For instance, the first view frame 400 can correspond to the rendered output view 360 of the oblique image viewer system 300 of FIG. 3. In particular, the first view frame 400 can be the rendered output view 360 prior to receiving a user input indicative of a manipulation operation to move (e.g., pan) the scene view to the left. The first view frame 400 may be associated with the first oblique image frame information 404, which can be the same as or similar to the oblique image frame information shown in FIG. 3 and described above with respect to the oblique images 325-1-325-N included within the oblique dataset 320.

The second view frame 450 corresponds to the rendered output view of the oblique image viewer system after receiving the user input to pan left, and after identifying a new best-fit matching oblique image given the new view perspective information determined after the pan left input is processed. In one illustrative example, the second view frame 450 can be associated with the second oblique image frame information 454, which can be the same as or similar to the oblique image frame information shown in FIG. 3 and described above with respect to the oblique images 325-1-325-N included within the oblique dataset 320.

Notably, the two oblique images 400 and 450 shown in FIG. 4 are not combined, stitched, or composited to support the transition between the two different viewpoint perspectives before and after the user pan left input. Instead, the two oblique images 400 and 450 remain separate, singular oblique images, that are identified and selected for output based on each image being determined to be the best-fit match for a current request scene view indicated in the user inputs. The distinction between the first and second oblique image frames 400 and 450 is illustrated in FIG. 4 by the slight shift in the perspective (e.g., viewing angle) between the first oblique image frame 400 and the second oblique image frame 450.

In some aspects, the non-composite oblique imagery viewer system disclosed herein may receive a user input indicative of a manipulation or change in the requested viewpoint into the geographic scene, and may determine that the most recently displayed oblique image (e.g., the best-fit matching oblique image for the requested viewpoint immediately prior to receiving the user input indicative of the manipulation or change) remains the best-fit matching oblique image for the new requested viewpoint after the user input indicating the requested manipulation or change. For example, if the currently displayed oblique image still best matches the desired viewing criteria after receiving user input(s) indicating a pan, rotation, or other manipulation of the scene view, the non-composite oblique imagery viewer can be configured to continue showing the same oblique image (with the cropping/zoom level adjusted as needed to match any change to the center point or zoom level in the updated desired viewing criteria).

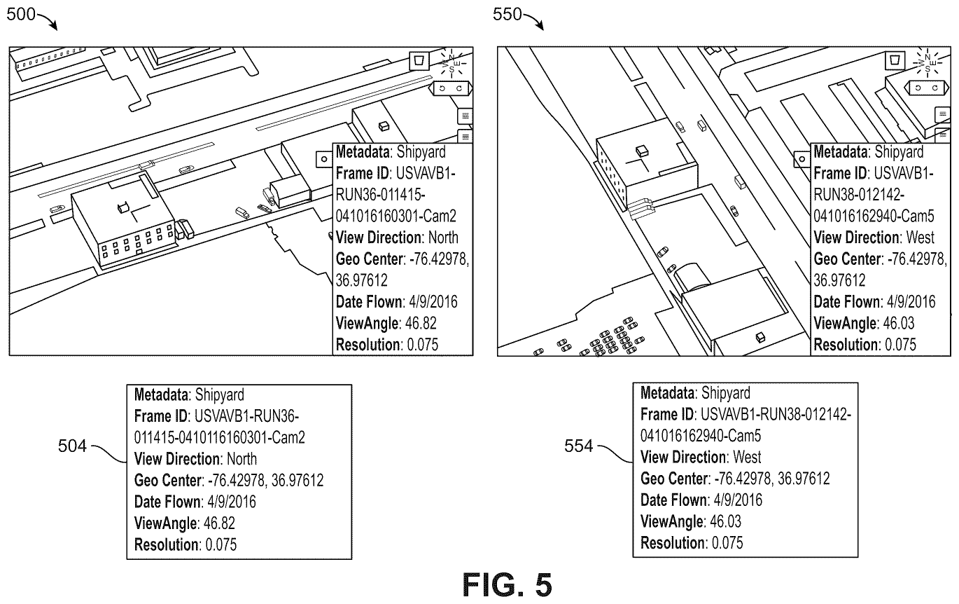

FIG. 5 is a diagram illustrating an example of a rotation operation corresponding to a first view frame 500 and a second view frame 550 of a geographic scene visualization, wherein the first and second view frames are based on separate and non-composite oblique images, in accordance with some examples. For instance, the first view frame 500 can correspond to the rendered output view 360 of the oblique image viewer system 300 of FIG. 3. In particular, the first view frame 500 can be the rendered output view 360 prior to receiving a user input 315 indicative of a manipulation operation to rotate the scene view to a new desired heading (e.g., orientation angle). The first view frame 500 can be associated with a first oblique image frame information 504. In some examples, the first view frame 500 of FIG. 5 is the same as the second view frame 450 of FIG. 4, and the first oblique image frame information 504 of FIG. 5 is the same as the second oblique image frame information 454 of FIG. 4.

In some aspects, the second view frame 550 of FIG. 5 can correspond to the rendered output view of the oblique image viewer system after receiving and processing the user input to rotate the viewpoint orientation 90 degrees clockwise. The second view frame 550 can be associated with second oblique image frame information 554, which can be the same as or similar to the oblique image frame information shown in FIG. 3 and described previously above with respect to the oblique images 325-1-325-N included within the oblique dataset 320 of FIG. 3.

In one illustrative example, the second oblique frame 550 is selected and obtained as a completely different oblique image than the first oblique frame 500. The second oblique frame 550 can be an oblique image that was taken from the same perspective requirements as the first oblique frame 500, except with the direction (heading/orientation angle) of the viewpoint changed according to the user input indicating the desired manipulation of a 90 degree clockwise rotation.

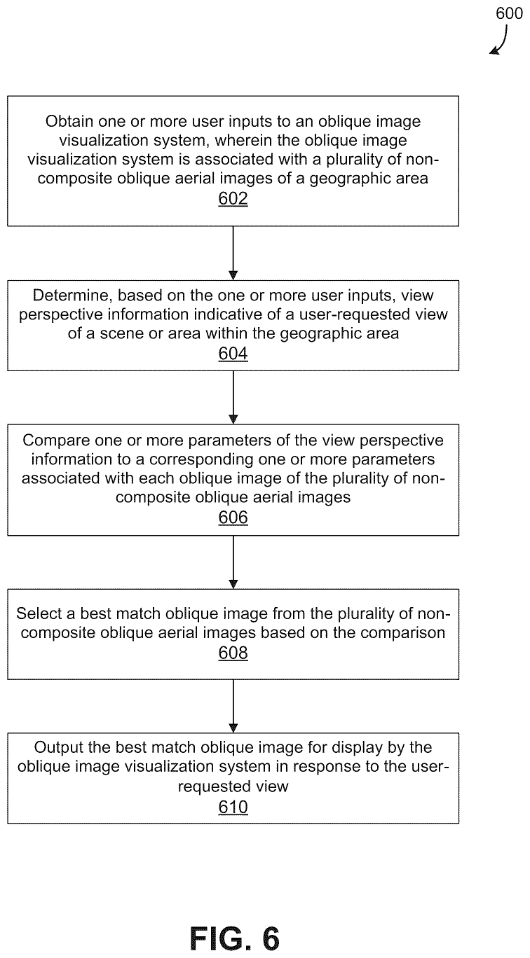

FIG. 6 is a flowchart diagram illustrating an example of a process 600 for the visualization and/or manipulation of non-composite oblique aerial imagery corresponding to a geographic scene or area of interest. In one illustrative example, the process 600 can be implemented by an oblique imagery viewer system, such as the oblique imagery viewer system 300 of FIG. 3, etc. In some aspects, at block 602, the process 600 can include obtaining one or more user inputs to an oblique image visualization system, wherein the oblique image visualization system is associated with a plurality of non-composite oblique aerial images of a geographic area of interest. At block 604, the process 600 can include determining, based on the one or more user inputs, view perspective information indicative of a user-requested view of a scene or area within the geographic area of interest. At block 606, the process 600 can include comparing one or more parameters of the view perspective information to a corresponding one or more parameters associated with each oblique image of the plurality of non-composite oblique aerial images. At block 608, the process 600 can include selecting a best match oblique image from the plurality of non-composite oblique aerial images based on the comparison. At block 610, the process 600 can include outputting the best match oblique image for display by the oblique image visualization system in response to the user-requested view.

Notably, the systems and techniques described herein can be used to provide or obtain visualization from a combination of a top-down view and a two-dimensional orthographic projection of survey data, including building exterior survey data and building interior survey data (e.g., floor level 3D scans and/or models, etc.). Using the combination of the top-down view and/or 3D view, along with the presently disclosed 2D orthographic projection views corresponding to specific floors of a building, the systems and techniques described herein can be used (e.g., by emergency responders, or other users of the 3D mapping and visualization system) to identify a location of interest from nearby landmarks, rather than performing the reverse as would be conventionally or otherwise required (e.g., finding a location, and subsequently identifying landmarks nearby or corresponding to the already-identified location). Notably, the top-down view 2D orthographic projections corresponding to a selected or identified building floor can include the plurality of visual landmarks described above, which may be used to perform or enable the identification of the location of interest based on landmarks on or within a particular floor.

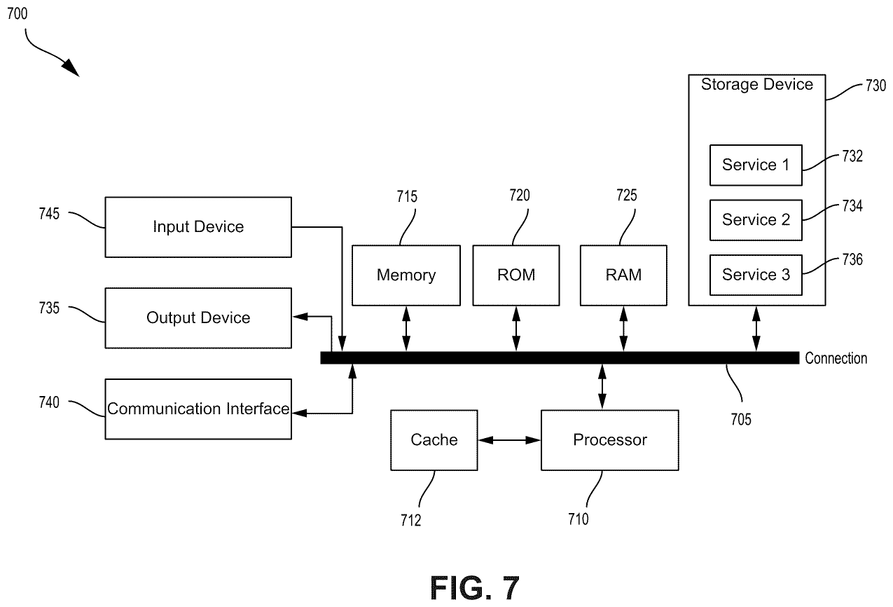

The operations of the process 600 may be implemented as software components that are executed and run on one or more processors (e.g., processor 710 of FIG. 7 or other processor(s)). In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 600 is illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, the process 600 and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 7 is a diagram illustrating an example of a system for implementing certain aspects of the present technology. In particular, FIG. 7 illustrates an example of computing system 700, which may be for example any computing device making up internal computing system, a remote computing system, a camera, or any component thereof in which the components of the system are in communication with each other using connection 705. Connection 705 may be a physical connection using a bus, or a direct connection into processor 710, such as in a chipset architecture. Connection 705 may also be a virtual connection, networked connection, or logical connection.

In some aspects, computing system 700 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 700 includes at least one processing unit (CPU or processor) 710 and connection 705 that communicatively couples various system components including system memory 715, such as read-only memory (ROM) 720 and random access memory (RAM) 725 to processor 710. Computing system 700 may include a cache 715 of high-speed memory connected directly with, in close proximity to, or integrated as part of processor 710.

Processor 710 may include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 includes an input device 745, which may represent any number of input mechanisms, such as a microphone for speech, a touch-sensitive screen for gesture or graphical input, keyboard, mouse, motion input, speech, etc. Computing system 700 may also include output device 735, which may be one or more of a number of output mechanisms. In some instances, multimodal systems may enable a user to provide multiple types of input/output to communicate with computing system 700.

Computing system 700 may include communications interface 740, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 may be a non-volatile and/or non-transitory and/or computer-readable memory device (e.g., such as one or more computer-readable storage media) and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L#) cache), resistive random-access memory (RRAM/ReRAM), phase change memory (PCM), spin transfer torque RAM (STT-RAM), another memory chip or cartridge, and/or a combination thereof. In some cases, the one or more computer-readable storage media may additionally, or alternatively, correspond to any type of disc, smart card, storage drive(s) (including portable drives, shared drives, network drives, etc.), network shared points, cloud and/or networked storage systems, platforms, services, etc.

The storage device 730 may include software services, servers, services, etc., that when the code that defines such software is executed by the processor 710, it causes the system to perform a function. In some aspects, a hardware service that performs a particular function may include the software component stored in a computer-readable medium in connection with the necessary hardware components, such as processor 710, connection 705, output device 735, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

What is claimed is:

1. A method comprising:
obtaining one or more user inputs to an oblique image visualization system, wherein the oblique image visualization system is associated with a plurality of non-composite oblique aerial images of a geographic area;
determining, based on the one or more user inputs, view perspective information indicative of a user-requested view of a scene or area within the geographic area;
comparing one or more parameters of the view perspective information to a corresponding one or more parameters associated with each oblique image of the plurality of non-composite oblique aerial images;
selecting a best match oblique image from the plurality of non-composite oblique aerial images based on the comparison; and
outputting the best match oblique image for display by the oblique image visualization system in response to the user-requested view.

2. The method of claim 1, further comprising:
determining a difference between values of the one or more parameters of the view perspective information and respective values of the corresponding one or more parameters associated with each oblique image.

3. The method of claim 2, wherein the best match oblique image is selected based on having a minimum difference from the values of the one or more parameters of the view perspective information.

4. The method of claim 1, wherein the geographic area is a geographic area of interest identified from one or more user inputs, and wherein the view perspective information includes at least a center point coordinate of the user-requested view of the scene or area within the geographic area of interest.

5. The method of claim 4, wherein:
each oblique image of the plurality of non-composite oblique aerial images is associated with a respective image frame center coordinate; and
the best match oblique image is selected based on having a smallest distance between the center point coordinate of the user-requested view and the respective image frame center coordinate.

6. The method of claim 5, wherein the center point coordinate of the user-requested view and the respective image frame center coordinate for each oblique image are defined using a same common coordinate system.

7. The method of claim 1, wherein the view perspective information is indicative of one or more of:
a center point coordinate of the user-requested view;
an oblique view angle of the user-requested view;
a heading or orientation angle of the user-requested view; or
a zoom level of the user-requested view.

8. The method of claim 7, further comprising:
filtering the plurality of non-composite oblique aerial images to obtain a filtered subset of oblique images, wherein the filtered subset of oblique images each have corresponding parameter values matching with one or more of the oblique view angle and the heading or orientation angle of the user-requested view.

9. The method of claim 8, wherein the best match oblique image is determined based on a calculated straight line distance between the center point coordinate of the user-requested view and a respective image frame center coordinate for each oblique image included in the filtered subset.

10. The method of claim 9, wherein determining the calculated straight line distance is skipped for each oblique image of the plurality of non-composite oblique aerial images that is not included in the filtered subset.

11. The method of claim 1, wherein outputting the best match oblique image for display includes cropping the best match oblique image data to match the user-requested view of the scene or area within the geographic area.

12. The method of claim 11, wherein the best match oblique image data is cropped based on one or more of a configured zoom level or a configured center point coordinate indicated in the view perspective information for the user-requested view.

13. A system comprising:
one or more processors; and
one or more computer-readable storage media having computer-readable instructions stored thereon, wherein the computer-readable instructions, when executed by the one or more processors, cause the one or more processors to:
obtain one or more user inputs to an oblique image visualization system, wherein the oblique image visualization system is associated with a plurality of non-composite oblique aerial images of a geographic area;
determine, based on the one or more user inputs, view perspective information indicative of a user-requested view of a scene or area within the geographic area;
compare one or more parameters of the view perspective information to a corresponding one or more parameters associated with each oblique image of the plurality of non-composite oblique aerial images;
select a best match oblique image from the plurality of non-composite oblique aerial images based on the comparison; and
output the best match oblique image for display by the oblique image visualization system in response to the user-requested view.

14. The system of claim 13, wherein the computer-readable instructions further cause the one or more processors to:
determine a difference between values of the one or more parameters of the view perspective information and respective values of the corresponding one or more parameters associated with each oblique image; and
select the best match oblique image based on the best match oblique image having a minimum difference from the values of the one or more parameters of the view perspective information.

15. The system of claim 13, wherein:
the view perspective information includes at least a center point coordinate of the user-requested view of the scene or area within the geographic area;
each oblique image of the plurality of non-composite oblique aerial images is associated with a respective image frame center coordinate; and
the best match oblique image is selected based on having a smallest distance between the center point coordinate of the user-requested view and the respective image frame center coordinate.
